(19) United States
(12) Patent Application Publication
(10) Pub. No.: US 2014/0351811 A1
(43) Pub. Date: Nov. 27, 2014

(54) DATACENTER APPLICATION PACKAGES WITH HARDWARE ACCELERATORS

(71) Applicant: Empire Technology Development LLC, Wilmington, DE (US)

(72) Inventor: Ezekiel Kruglick, Poway, CA (US)

(21) Appl. No.: 14/234,380

(22) PCT Filed: May 24, 2013
(86) PCT No.: PCT/US13/42759

§ 371 Date: Jul. 12, 2014

(51) Int. Cl. G06F 9/455

(52) U.S. Cl. CPC G06F 9/45533
USPC 718/1

(57) ABSTRACT

Technologies are generally described for providing application packages with hardware accelerators. In some examples, an application package for a datacenter may include an application and multiple hardware accelerators associated with the application. Each hardware accelerator may be configured for a different datacenter hardware configuration. When a datacenter receives the application package, it may select the appropriate hardware accelerator for implementation based on its hardware configuration.

### BACKGROUND

Unless otherwise indicated herein, the materials described in this section are not prior art to the claims in this application and are not admitted to be prior art by inclusion in this section.

Applications intended for deployment at datacenters may be distributed as application packages. Such application packages may be platform- or hardware-independent, so that a single application package may be distributed to different datacenter types.

At the same time, hardware accelerators to improve the performance and efficiency of datacenter applications are becoming more common. The implementation of such hardware accelerators may be closely related to the type of hardware present at a datacenter, and hence may not be platform or hardware-independent.

### SUMMARY

The present disclosure generally describes techniques for providing application packages with hardware accelerators.

According to some examples, a method is provided for implementing an application and an associated hardware accelerator at a datacenter. The method may include receiving an application package including an application and multiple hardware accelerators associated with the application at a datacenter, deploying the application on a virtual machine (VM) at the datacenter, selecting one of the hardware accelerators based on a datacenter characteristic, and deploying the selected hardware accelerator at the datacenter.

According to other examples, a virtual machine manager (VMM) to implement an application and an associated hardware accelerator at a datacenter is provided. The VMM may include a memory configured to store instructions, a processing module coupled to the memory, and a configuration controller. The processing module may be configured to receive an application package including an application and multiple hardware accelerators associated with the application and deploy the application on a virtual machine (VM) at the datacenter. The configuration controller may be configured to select one of the hardware accelerators based on a datacenter characteristic and deploy the selected hardware accelerator at the datacenter.

According to further examples, a cloud-based datacenter configured to implement an application and an associated hardware accelerator is provided. The datacenter may include at least one virtual machine (VM) operable to be executed on one or more physical machines, a hardware acceleration module, and a datacenter controller. The datacenter controller may be configured to receive an application package including an application and multiple hardware accelerators associated with the application, deploy the application on the at least one VM, select one of the hardware accelerators based on a characteristic of the hardware acceleration module, and deploy the selected hardware accelerator on the hardware acceleration module.

According to yet further examples, a method is provided for packaging a datacenter application. The method may include adding an application to a virtualization wrapper, generating multiple hardware accelerators associated with the application, each hardware accelerator generated based on a different datacenter hardware configuration, and adding the generated hardware accelerators to the virtualization wrapper.

According to some examples, an application package to implement at a datacenter is provided. The application package may include a virtualization wrapper, an application included in the virtualization wrapper, and multiple hardware accelerators included in the virtualization wrapper, each hardware accelerator associated with the application and based on a different datacenter hardware configuration.

According to other examples, another method is provided for implementing an application and an associated hardware accelerator at a datacenter. The method may include forming an application package by adding an application to a virtualization wrapper, generating multiple hardware accelerators associated with the application, each hardware accelerator generated based on a different datacenter hardware configuration, and adding the generated hardware accelerators to the virtualization wrapper. The method may further include receiving the application package at a datacenter, deploying the application on a virtual machine (VM) at the datacenter, selecting one of the hardware accelerators based on a datacenter characteristic or a hardware map included in the application package, and deploying the selected hardware accelerator at the datacenter.

According to further examples, a computer readable medium may store instructions for implementing an application and an associated hardware accelerator at a datacenter. The instructions may include receiving an application package including an application and multiple hardware accelerators associated with the application at a datacenter, deploying the application on a virtual machine (VM) at the datacenter, selecting one of the hardware accelerators based on a datacenter characteristic, and deploying the selected hardware accelerator at the datacenter.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example datacenter-based system where applications and associated hardware accelerators may be implemented;

FIG. 2 illustrates an example system at a datacenter where applications and associated hardware accelerators may be implemented;

FIG. 3 illustrates the example system of FIG. 2 where an application and an associated hardware accelerator may be implemented from different sources;

FIG. 4 illustrates an example system where an application and an associated hardware accelerator may be implemented from a single application package;

FIG. 5 illustrates a general purpose computing device, which may be used to assemble application packages including hardware accelerators;

FIG. 6 illustrates a general purpose computing device which may be used to implement an application and an associated hardware accelerator;

FIG. 7 is a flow diagram illustrating an example method for assembling application packages that may be performed by a computing device such as the computing device in FIG. 5;

FIG. 8 is a flow diagram illustrating an example method for implementing an application and an associated hardware accelerator that may be performed by a computing device such as the computing device in FIG. 6; and

FIGS. 9 and 10 illustrate block diagrams of example computer program products,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to providing application packages with hardware accelerators.

Briefly stated, technologies are generally described for providing application packages with hardware accelerators. In some examples, an application package for a datacenter may include an application and multiple hardware accelerators associated with the application. Each hardware accelerator may be configured for a different datacenter hardware configuration. When a datacenter receives the application package, it may select the appropriate hardware accelerator for implementation based on the datacenter's hardware configuration.

A datacenter as used herein refers to an entity that hosts services and applications for customers through one or more physical server installations and one or more virtual machines executed in those server installations. Customers of the datacenter, also referred to as tenants, may be organizations that provide access to their services for multiple users. One example configuration may include an online retail service that provides retail sale services to consumers (users). The retail service may employ multiple applications (e.g., presentation of retail goods, purchase management, shipping management, inventory management, etc.), which may be hosted by one or more datacenters. Thus, a consumer may communicate with those applications of the retail service through a client application such as a browser over one or more networks and receive the provided service without realizing where the individual applications are actually executed. This scenario contrasts with configurations where each service provider would execute their applications and have their users access those applications on the retail service's own servers physically located on retail service premises. One result of the networked approach described herein is that customers like the retail service may move their hosted services/applications from one datacenter to another without the users noticing a difference.

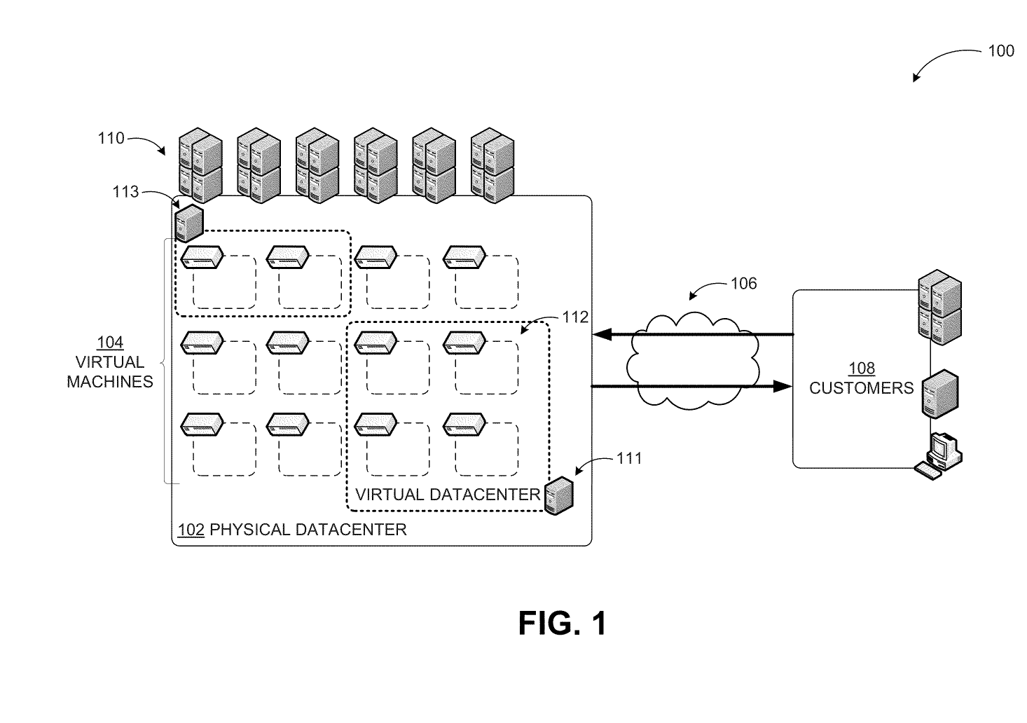

FIG. 1 illustrates an example datacenter-based system where applications and associated hardware accelerators may be implemented, arranged in accordance with at least some embodiments described herein.

As shown in a diagram 100, a physical datacenter 102 may include one or more physical servers 110, 111, and 113, each of which may be configured to provide one or more virtual machines 104. For example, the physical servers 111 and 113 may be configured to provide four virtual machines and two virtual machines, respectively. In some embodiments, one or more virtual machines may be combined into one or more virtual datacenters. For example, the four virtual machines provided by the server 111 may be combined into a virtual datacenter 112. The virtual machines 104 and/or the virtual datacenter 112 may be configured to provide cloud-related data/computing services such as various applications, data storage, data processing, or comparable ones to a group of customers 108, such as individual users or enterprise customers, via a cloud 106.

According to some embodiments, an accelerator wrapper-within-a-wrapper may be structured for datacenter wrapped applications such that the package includes multiple configware or configuration programs/files for programming different target reconfigurable hardware and a datacenter-side module to take apart the wrapper-within-a-wrapper. The correct configware may be selected for local hardware and any environmental variables needed in a virtual machine may be set to indicate which accelerators are present. Thus, the entire wrapped package may be prepared including hardware acceleration for use on the currently used specific hardware.

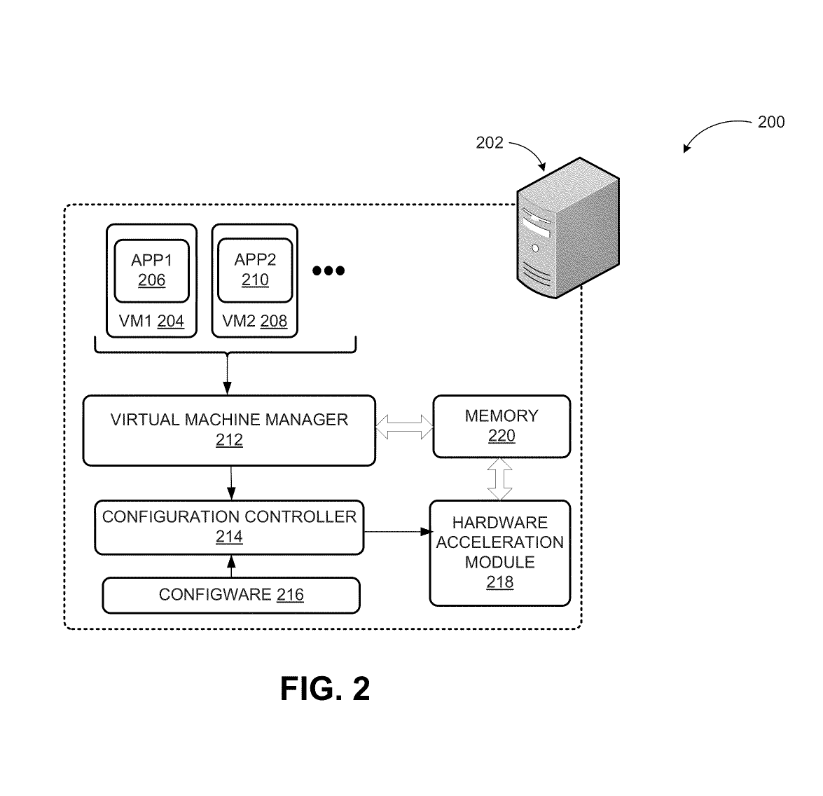

FIG. 2 illustrates an example system at a datacenter where applications and associated hardware accelerators may be implemented, arranged in accordance with at least some embodiments described herein.

As shown in a diagram 200, a physical server 202 (e.g., the physical servers 110, 111, or 113 in FIG. 1) may be configured to execute a number of virtual machines, such as a first virtual machine 204, a second virtual machine 208, and other virtual machines (not shown). Each of the virtual machines may implement one or more applications. For example, the first virtual machine 204 may implement a first application 206 and the second virtual machine 208 may implement a second application 210. A virtual machine manager (VMM) 212 may be configured to manage the virtual machines, and also load applications onto the virtual machines. For example, the VMM 212 may load the first application 206 and the second application 210 onto the first virtual machine 204 and the second virtual machine 208, respectively.

The physical server 202 may also include a hardware acceleration module 218. The hardware acceleration module 218 may be configured to implement hardware accelerators to increase computing efficiency and lower operating costs for parallelizable processes or applications. In some embodiments, the hardware acceleration module 218 may include a field-programmable gate array (FPGA) having multiple logic cells or digital units, which may be combined to form circuits and/or processors with various functionalities. A configuration controller 214 may be configured to load one or more hardware accelerators (e.g., as one or more configware or configuration files, described in more detail below) onto the hardware acceleration module 218. In some embodiments, each hardware accelerator loaded on the hardware acceleration module 218 may be associated with one or more applications implemented on the virtual machines. For example, one hardware accelerator may be associated with the first application 206 and another hardware accelerator may be associated with the second application 210. In some embodiments, the virtual machines 204, 208 may transfer part of their computing loads to the associated hardware accelerators on the hardware acceleration module 218 by, for example, communicating data via a system memory 220. This may increase the computing efficiency and speed of the virtual machines 204, 208 and the applications 206, 210.

In some embodiments, the configuration controller 214 may be configured to load hardware accelerators onto the hardware acceleration module 218 based on one or more configuration programs or configware 216, which may be stored in memory. The configware 216 may include descriptor files for hardware accelerators to be loaded onto the hardware acceleration module 218. For example, the descriptor files in the configware 216 may list the various digital elements and inputs/outputs to be connected on the hardware acceleration module 218 in order to load a particular hardware accelerator on the hardware acceleration module 218. In some embodiments, the descriptor files may take the form of hardware descriptor language (HDL) files, which may be compiled to provide netlist files. The netlist files in turn may include detailed lists of connections and elements of the hardware accelerator circuits. Formats other than HDL may also be used for implementing various embodiments. In some embodiments, the configware 216 may also (or instead) include binary files corresponding to hardware accelerators, for example compiled from the appropriate descriptor files.

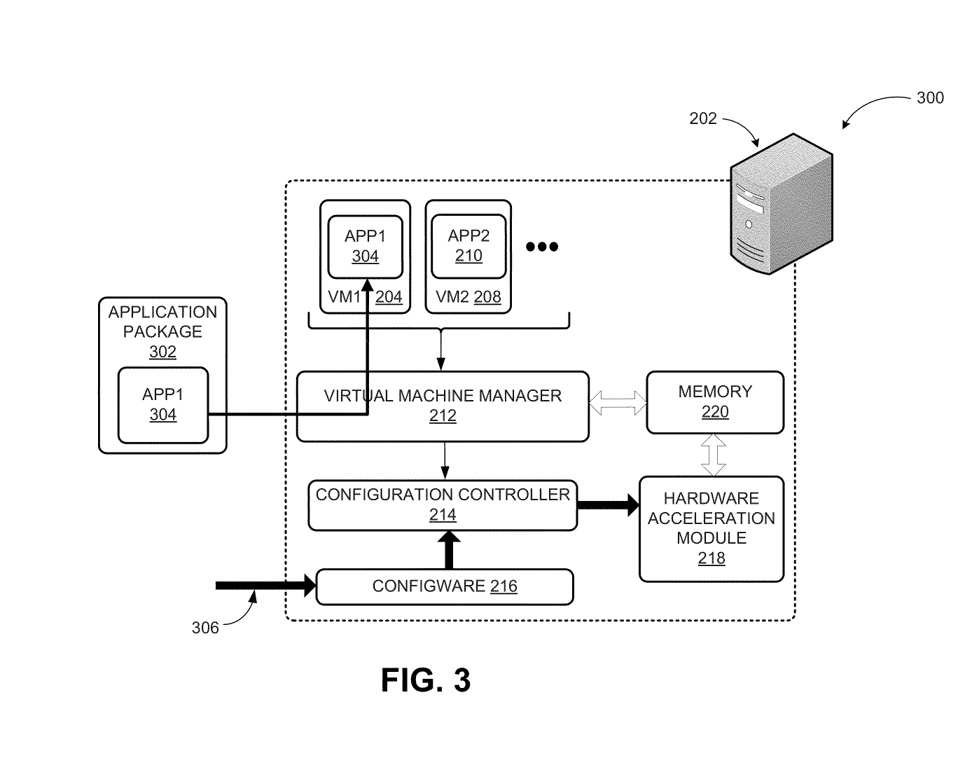

FIG. 3 illustrates the example system of FIG. 2, where an application and an associated hardware accelerator may be implemented from different sources, arranged in accordance with at least some embodiments described herein.

As described above, a VMM (e.g., the VMM 212) may be configured to load applications (e.g., the first application 206) onto virtual machines (e.g., the first virtual machine 204). In some embodiments, a datacenter may receive applications to be loaded onto virtual machines in the form of application packages. An application package may include a virtualization wrapper, which in turn includes an application to be deployed on virtual machines. In some embodiments, the application package/virtualization wrapper may be platform-independent and may be used to distribute the same application to different datacenters.

Hardware virtualization or platform virtualization refers to the creation of a virtual machine that acts like a real computer. Programs executed on the virtual machines may be separated from the underlying hardware resources. For example, a server that is running one operating system may host a virtual machine that looks like a server with another operating system. Furthermore, multiple virtual machines may be hosted on a single server giving the appearance of multiple servers. In hardware virtualization, a host machine is the physical machine on which the virtualization takes place, and a guest machine refers to the virtual machine. Different types of hardware virtualization may include (1) full virtualization: almost complete simulation of the actual hardware to allow software, which may typically include a guest operating system, to run unmodified; (2) partial virtualization: some but not all of the target environment may be simulated, where some guest programs may need modifications to run in this virtual environment; (3) para-virtualization: a hardware environment may not be simulated, however, the guest programs may be executed in their own isolated domains, as if they are running on a separate system.

As shown in a diagram 300, the physical server 202 (or its associated datacenter, e.g. the physical datacenter 102) may receive an application package 302 containing an application 304 to be loaded on a virtual machine. The VMM 212 may be configured to extract the application 304 from the application package 302 and load the application 304 onto the first virtual machine 204. The application package 302 may be platform-independent, such that the same application package 302 may be used to deploy the application 304 across many different datacenter types (e.g., datacenters having different processors, operating systems, configurations, etc.).

In some embodiments, the application 304 may have an associated hardware accelerator configured to increase the computing efficiency and speed of the application 304 and/or a virtual machine implementing the application 304. Hardware accelerators, as described above, may be implemented from HDL files and/or netlist files or other formats. In some embodiments, the final implementation of a particular hardware accelerator may be hardware-specific. For example, a hardware accelerator for implementation on an FPGA may be built by starting with a hardware-independent form, such as an HDL file. The HDL file may then be processed using, for example, an electronic design automation (EDA) tool that in many cases may be tied to particular technologies or vendors. The result of this processing may be a hardware-specific netlist file, which may vary depending on the particular vendor or hardware (e.g., FPGA processor type/generation). The netlist file may then be subject to a place-and-route process, which may again be hardware-specific, resulting in a binary file ready for implementation on a particular type of hardware. Since the application package 302 may be platform-independent, as described above, it may not contain a hardware accelerator implementation suitable for the hardware acceleration module 218, or in fact any hardware accelerator implementations at all. Therefore, the datacenter/physical server 202 may have to separately retrieve a hardware accelerator implementation 306 suitable for the application 304 and the hardware acceleration module 218. For example, the datacenter may determine hardware information associated with the hardware acceleration module 218, retrieve the appropriate hardware accelerator implementation 306, and then implement the retrieved hardware accelerator implementation 306 as described above. In particular, this hardware accelerator implementation process may be separate from the application implementation process using the application package 302, and may add complexity to the process of distributing and supporting applications with custom hardware accelerators.

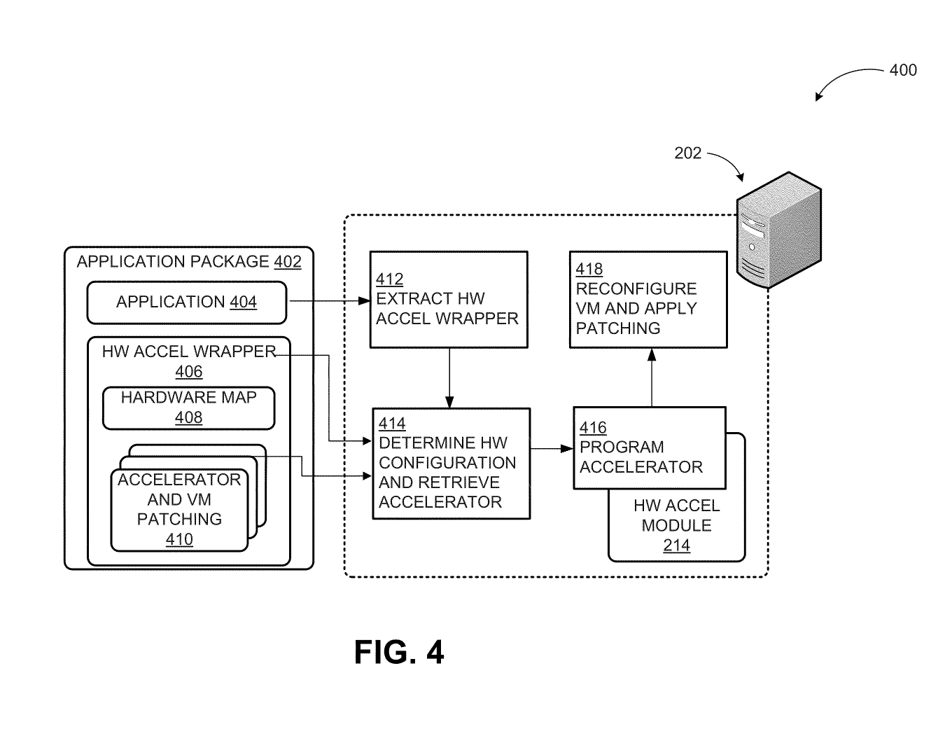

FIG. 4 illustrates an example system where an application and an associated hardware accelerator may be implemented from a single application package, arranged in accordance with at least some embodiments described herein.

As shown in a diagram 400, the physical server 202 may receive an application package 402. The application package 402 may be similar to the application package 302 in that it includes an application 404 (e.g., similar to the application 304). However, the application package 402 may also include a hardware accelerator wrapper 406. The hardware accelerator wrapper 406, which in some embodiments may be implemented as an extensible markup language (XML) wrapper, may contain one or more hardware accelerators 410 associated with the application 404. In some embodiments, the hardware accelerators 410 may include multiple versions of one or more hardware accelerators, each version arranged for a different hardware configuration. For example, a hardware accelerator version may be configured for a particular type of hardware acceleration module, a particular virtual machine type, a particular operating system type, and/or a particular processor type. In addition, the hardware accelerators 410 may also include virtual machine patching, settings data, and/or implementation parameters associated with each of the hardware accelerators. The VM patching/settings data may be used to configure a virtual machine on which the application 404 is implemented, for example to indicate whether and/or which hardware accelerator is available to the application 404 on the physical server 202. The implementation parameters may be used to assist in the implementation of the hardware accelerator on a hardware acceleration module. The hardware accelerator wrapper 406 may also include a hardware map 408 that contains information relating specific hardware configurations to specific hardware accelerators in the hardware accelerators 410.

In some embodiments, the hardware accelerators 410 included in the application package 402 may be implemented starting from a number of high-level HDL files corresponding to different accelerator classes. Netlist formation, place-and-route and/or simulation processes may then be used to generate the hardware accelerators and their associated virtual machine patching, settings data, and/or implementation parameters. The hardware accelerators 410 may then be included in the wrapper 406 as binary or HDL files along with the associated virtual machine patching, settings, and implementation parameters. In some embodiments, a hardware accelerator and its associated data may be combined together as a sub-package in the hardware accelerator wrapper 406.

After the physical server 202 receives the application package 402, in an operation 412, the hardware accelerator wrapper 406 may be extracted by, for example, a VMM (e.g., the VMM 212) or a configuration controller (e.g., the configuration controller 214) at the physical server 202. In a subsequent operation 414, the configuration controller may determine the hardware configuration associated with the physical server 202 and retrieve one of the hardware accelerators 410 and VM patching data associated with the retrieved hardware accelerator based on the determination. For example, the configuration controller may determine the type of a hardware acceleration module (e.g., the hardware acceleration module 214) at the physical server 202, a virtual machine type associated with the application 404, an operating system type, and/or a processor type. In some embodiments, the configuration controller may use the hardware map 408 to find the particular hardware accelerator in the hardware accelerators 410 corresponding to the hardware configuration of the hardware acceleration module 214. Next, in operation 416 the configuration controller may program the hardware acceleration module 214 with the retrieved hardware accelerator. For example, the retrieved hardware accelerator may be in the form of an HDL file, a netlist file, or a binary file, and the configuration controller may program an FPGA in the hardware acceleration module 214 based on the retrieved hardware accelerator file. If the hardware accelerator is provided as an HDL file and associated implementation parameters such as netlist formation parameters and/or place-and-route parameters, the configuration controller may combine the HDL file with the implementation parameters to program the hardware acceleration module 214. Finally, in operation 418 the VMM may reconfigure the virtual machine based on the VM patching data retrieved in the operation 414.

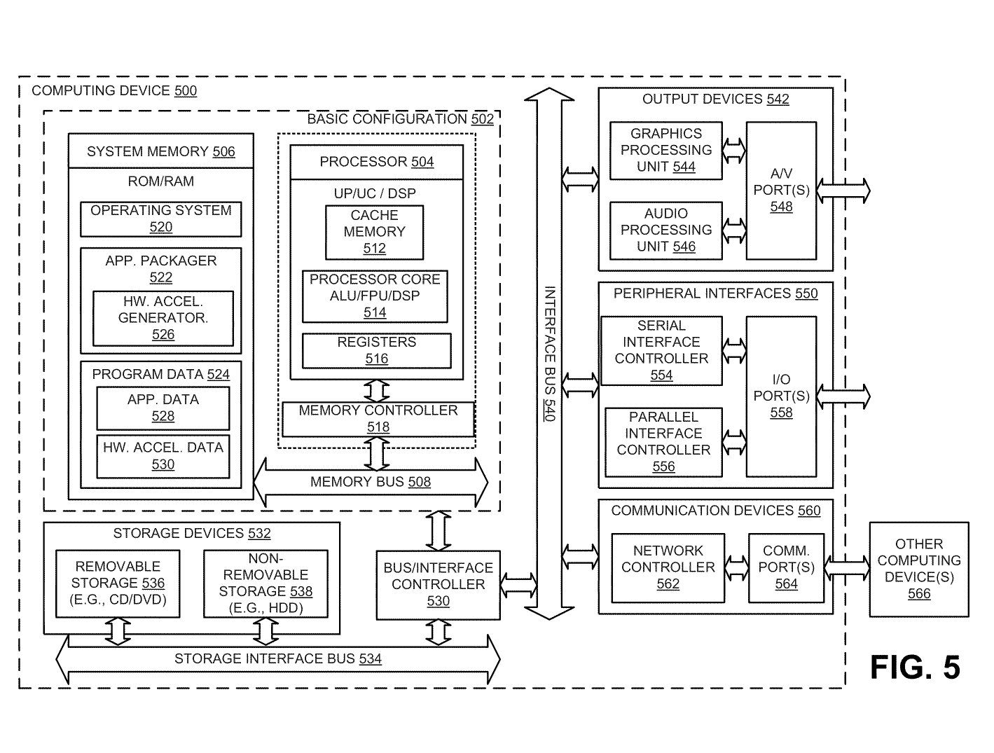

FIG. 5 illustrates a general purpose computing device, which may be used to assemble application packages including hardware accelerators, arranged in accordance with at least some embodiments described herein.

For example, the computing device 500 may be used to assemble application packages as described herein. In an example basic configuration 502, the computing device 500 may include one or more processors 504 and a system memory 506. A memory bus 508 may be used to communicate between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, a processor core 514, and registers 516. The example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including hut not limited to volatile memory (such as RAM), non-volatile memory (such as ROM, flash memory, etc.) or any combination thereof. The system memory 506 may include an operating system 520, an application packager 522, and program data 524. The application packager 522 may include a hardware accelerator generator 526 to generate hardware accelerators as described herein. The program data 524 may include, among other data, application data 528, hardware accelerator data 530, or the like, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HUD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., one or more output devices 542, one or more peripheral interfaces 544, and one or more communication devices 566) to the basic configuration 502 via the bus/interface controller 530. Some of the example output devices 542 include a graphics processing unit 548 and an audio processing unit 550, which may be configured to communicate to various external devices such as a display or speakers via one or more A/V ports 552. One or more example peripheral interfaces 544 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 566 includes a network controller 560, which may be arranged to facilitate communications with one or more other computing devices 562 over a network communication link via one or more communication ports 564. The one or more other computing devices 562 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RE), microwave, infrared (IR) and other wireless media. The term computer readable media as used herein may include both storage media and communication media.

The computing device 500 may be implemented as apart of a general purpose or specialized server, mainframe, or similar computer that includes any of the above functions. The computing device 500 may also be implemented as a personal computer including both laptop computer and non-laptop computer configurations.

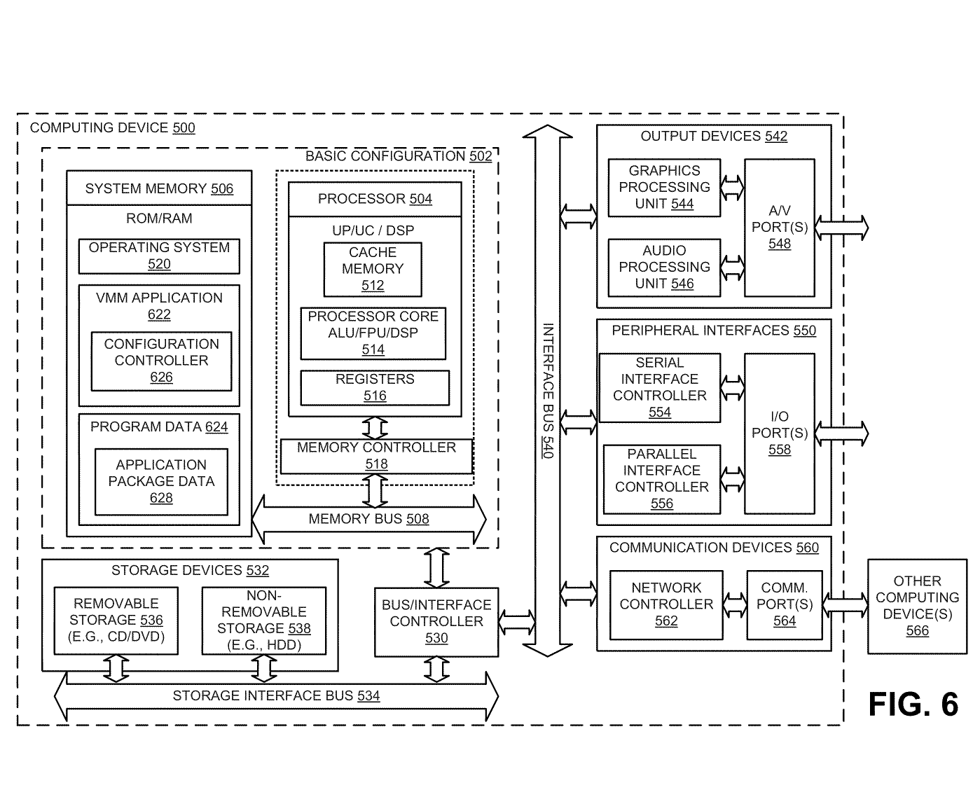

FIG. 6 illustrates a general purpose computing device which may be used to implement an application and an associated hardware accelerator, arranged in accordance with at least some embodiments described herein.

FIG. 6 is similar to FIG. 5, with similarly-numbered elements behaving substantially the same way. However, in FIG. 6 the system memory 506 may include a virtual machine manager (VMM) application 622 and program data 624. The VMM application 622 may include a configuration controller 626 to implement hardware accelerators selected from an application package as described herein. The program data 524 may include, among other data, application package data 628 or the like, as described herein.

Example embodiments may also include methods for assembling application packages or implementing an application and an associated hardware accelerator. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations white other operations may be performed by machines. These human operators need not be collocated with each other, but each can be with a machine that performs a portion of the program. In other examples, the human interaction can be automated such as by pre-selected criteria that may be machine automated.

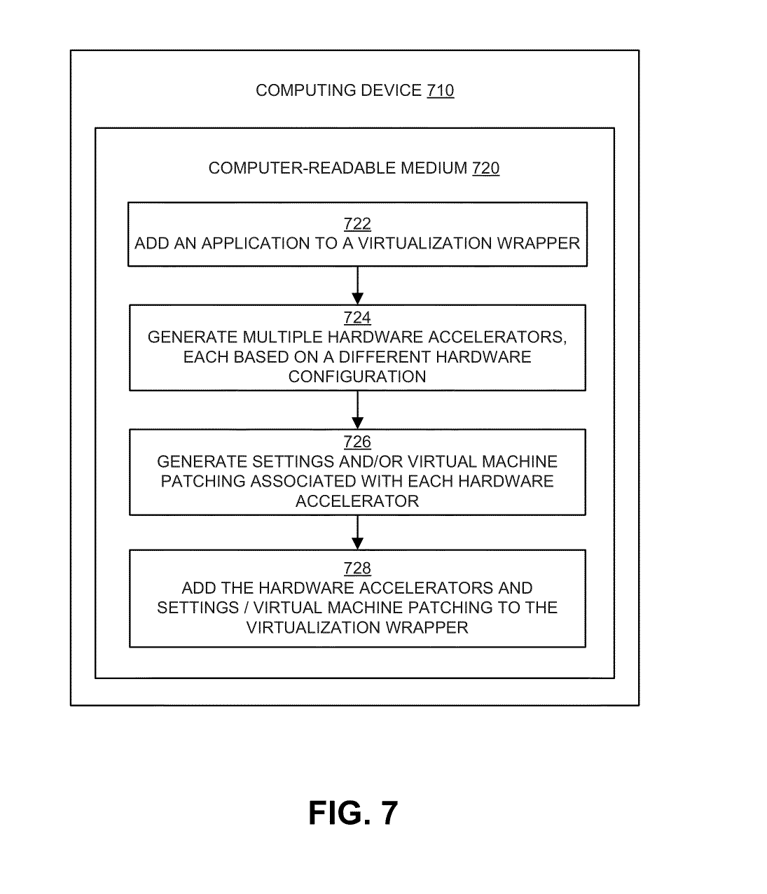

FIG. 7 is a flow diagram illustrating an example method for assembling application packages that may be performed by a computing device such as the computing device in FIG. 5, arranged in accordance with at least some embodiments described herein.

Example methods may include one or more operations, functions or actions as illustrated by one or more of blocks 722, 724, 726, and/or 728, and may in some embodiments be performed by a computing device such as the computing device 500 in FIG. 5. The operations described in the blocks 722-728 may also be stored as computer-executable instructions in a computer-readable medium such as a computer-readable medium 720 of a computing device 710.

An example process for assembling application packages may begin with block 722, “ADD AN APPLICATION TO A VIRTUALIZATION WRAPPER”, where an application to be deployed at a datacenter (e.g., the application 404) may be added to a virtualization wrapper in an application package (e.g., the application package 402) by the application packager application 522. In some embodiments, the application package itself may constitute the virtualization wrapper. As mentioned above, the virtualization wrapper or application package may be platform-independent or hardware-independent.

Block 722 may be followed by block 724, “GENERATE MULTIPLE HARDWARE ACCELERATORS, EACH BASED ON A DIFFERENT HARDWARE CONFIGURATION”, where multiple versions of hardware accelerator(s) associated with the application in the virtualization wrapper may be generated by the hardware accelerator generator 526. The hardware accelerators may be configured for implementation on a hardware acceleration module (e.g., the hardware acceleration module 218) such as an FPGA. Each hardware accelerator version may be generated for implementation on a different hardware acceleration module configuration. In some embodiments, the hardware accelerators may be generated from a number of high-level HDL files associated with different accelerator classes, as described above.

Block 724 may be followed by block 726, “GENERATE SETTINGS AND/OR VIRTUAL MACHINE PATCHING ASSOCIATED WITH EACH HARDWARE ACCELERATOR”, where virtual machine patching and settings data for each hardware accelerator may be generated by the hardware accelerator generator 526, for example by using netlist formation, place-and-route, and/or simulation processes as described above.

Finally, block 726 may be followed by block 728, “ADD THE HARDWARE ACCELERATORS AND SETTINGS/VIRTUAL MACHINE PATCHING TO THE VIRTUALIZATION WRAPPER”, where the hardware accelerators generated in block 724 and the virtual machine patching and settings generated in block 26 may be added to the virtualization wrapper by the application packager application 522. For example, the hardware accelerators and virtual machine patching may be added to a hardware accelerator wrapper (e.g., the hardware accelerator wrapper 406) in the application package, and in some embodiments each hardware accelerator and its associated virtual machine patching may be combined into a sub-package, as described above.

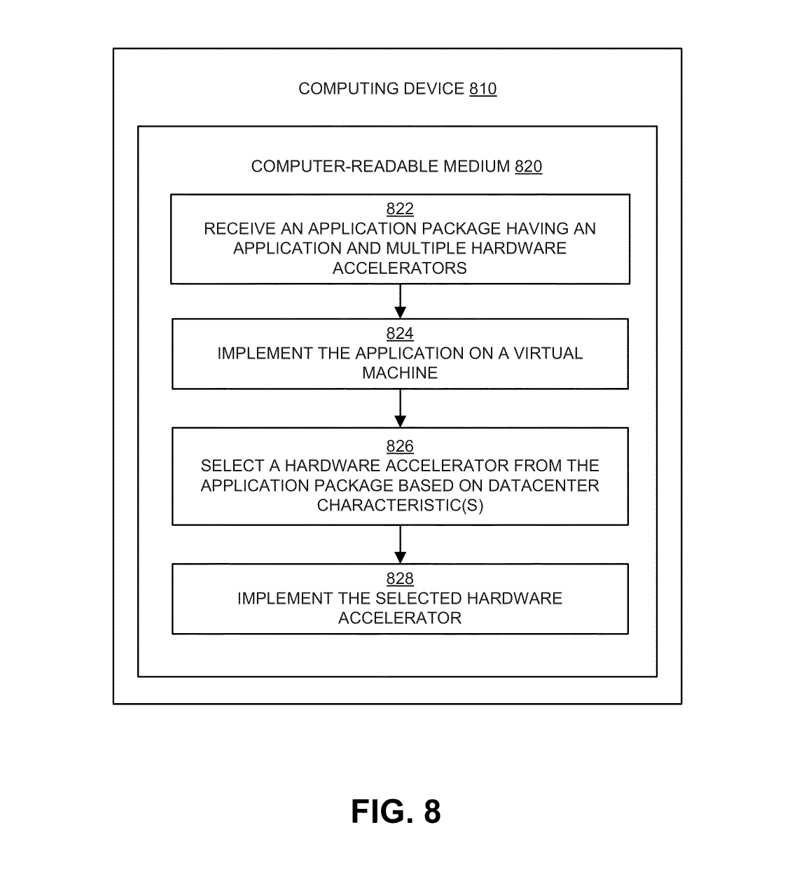

FIG. 8 is a flow diagram illustrating an example method for implementing an application and an associated hardware accelerator that may be performed by a computing device such as the computing device in FIG. 6, arranged in accordance with at least some embodiments described herein.

As with FIG. 7, example methods may include one or more operations, functions or actions as illustrated by one or more of blocks 822, 824, 826, and/or 828, and may in some embodiments be performed by a computing device such as the computing device 500 in FIG. 6. The operations described in the blocks 822-828 may also be stored as computer-executable instructions in a computer-readable medium such as a computer-readable medium 820 of a computing device 810.

An example process for implementing an application and are associated hardware accelerator may begin with block 822, “RECEIVE AN APPLICATION PACKAGE HAVING AN APPLICATION AND MULTIPLE HARDWARE ACCELERATORS”, where a datacenter (e.g., the datacenter 102) or a physical server (e.g., the physical server 202) may receive an application package (e.g., the application package 402) containing an application (e.g., the application 404) for deployment. The application package may also include one or more hardware accelerators (e.g., the hardware accelerators 410), as described above.

Block 822 may be followed by block 824, “IMPLEMENT THE APPLICATION ON A VIRTUAL MACHINE”, where a virtual machine manager (e.g., the VMM 212) may extract the application in the application package and implement it on one or more virtual machines.

Block 824 may be followed by block 826, “SELECT A HARDWARE ACCELERATOR FROM THE APPLICATION PACKAGE BASED ON DATACENTER CHARACTERISTIC(S)”, where a configuration controller (e.g., the configuration controller 214) may select one of the hardware accelerators included in the application package based on one or more datacenter characteristics, as described above. For example, the configuration controller may select the hardware accelerator based on the hardware configuration of a hardware acceleration module (e.g., the hardware acceleration module 214) at the datacenter. In some embodiments, the configuration controller may use a hardware map (e.g., the hardware map 408) to select a suitable hardware accelerator.

Block 826 may be followed by block 828, “IMPLEMENT THE SELECTED HARDWARE ACCELERATOR”, where the configuration controller may implement the selected hardware accelerator on a hardware acceleration module, as described above. For example, the selected hardware accelerator may be in the form of an HDL file, a netlist file, or a binary file, and the configuration controller may program the hardware acceleration module based on the hardware accelerator file. In some embodiments, the virtual machine manager may use virtual machine patching or settings data associated with the selected hardware accelerator to reconfigure the virtual machine on which the application is implemented.

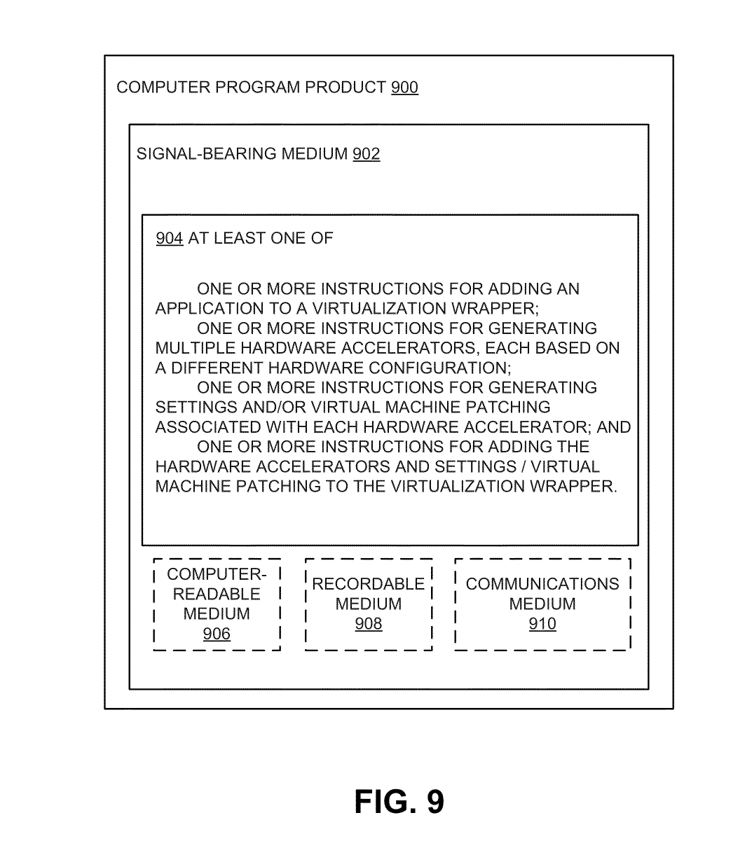

FIG. 9 illustrates a block diagram of an example computer program product, arranged in accordance with at least some embodiments described herein.

In some examples, as shown in FIG. 9, a computer program product 900 may include a signal bearing medium 902 that may also include one or more machine readable instructions 904 that, when executed by, for example, a processor may provide the functionality described herein. Thus, for example, referring to the processor 504 in FIG. 5, the application packager 522 may undertake one or more of the tasks shown in FIG. 9 in response to the instructions 904 conveyed to the processor 504 by the medium 902 to perform actions associated with assembling application packages with hardware accelerators as described herein. Some of those instructions may include, for example, adding an application to a virtualization wrapper, generating multiple hardware accelerators, each based on a different hardware configuration, generating settings and/or virtual machine patching associated with each hardware accelerator, and/or adding the hardware accelerators and settings/virtual machine patching to the virtualization wrapper, according to some embodiments described herein,

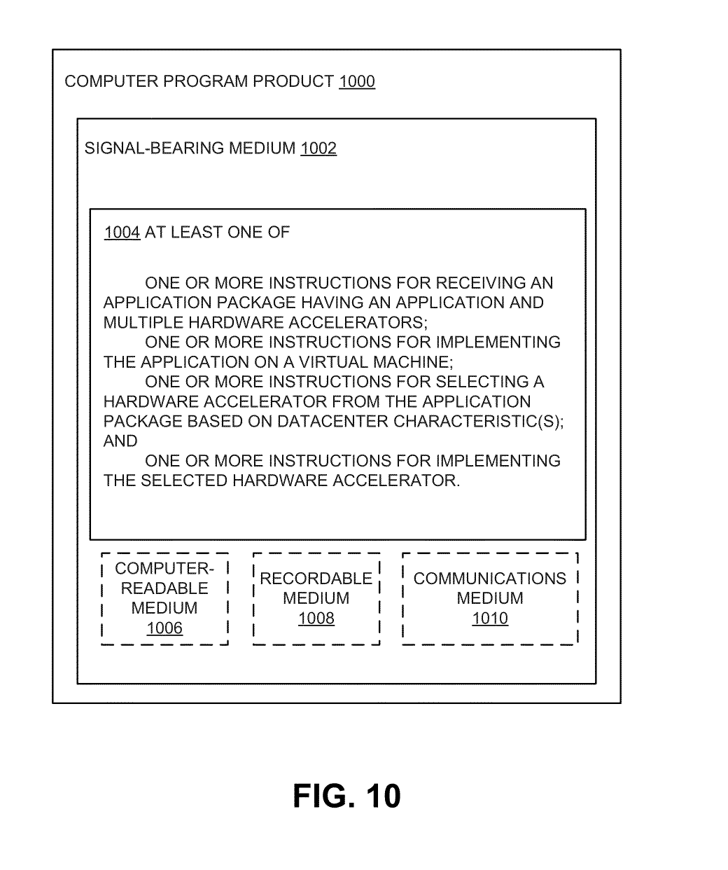

FIG. 10 illustrates a block diagram of another example computer program product, arranged in accordance with at least some embodiments described herein.

Similar to FIG. 9, a computer product 1000 may include a signal bearing medium 1002 that may also include one or more machine readable instructions 1004 that, when executed by, for example, a processor, may provide the functionality described herein. Thus, for example, referring to the processor 504 in FIG. 6, the VMM application 622 may undertake one or more of the tasks shown in FIG. 10 in response to the instructions 1004 conveyed to the processor 504 by the medium 1002 to perform actions associated with implementing an application and an associated hardware accelerator as described herein. Some of those instructions may include, for example, receiving an application package having an application and multiple hardware accelerators, implementing the application on a virtual machine, selecting a hardware accelerator from the application package based on one or more datacenter characteristics, and/or implementing the selected hardware accelerator, according to some embodiments described herein.

In some implementations, the signal bearing media 902 and 1002 depicted in FIGS. 9 and 10 may encompass computer-readable media 906 and 1006, such as, but not limited to, a hard disk drive, a solid state drive, a Compact Disc (CD), a Digital Versatile Disk (DVD), a digital tape, memory, etc. In some implementations, the signal bearing media 902/1002 may encompass recordable media 907/1007, such as, but not limited to, memory, read/write (R/W) CDs, R/W DVDs, etc. In some implementations, the signal bearing media 902/1002 may encompass communications media 910/1010, such as, but not limited to, a digital and/or an analog communication medium (e.g., a fiber optic cable, a waveguide, a wired communications link, a wireless communication link, etc.). Thus, for example, the program products 900/1000 may be conveyed to one or more modules of the processor 504 by an RF signal bearing medium, where the signal bearing media 902/1002 is conveyed by the wireless communications media 910/1010 (e.g., a wireless communications medium conforming with the IEEE 802.11 standard).

According to some examples, a method for implementing applications and associated hardware accelerators at a datacenter may include receiving an application package including an application and multiple hardware accelerators associated with the application at a datacenter, deploying the application on a virtual machine (VM) at the datacenter, selecting one of the hardware accelerators based on a datacenter characteristic, and deploying the selected hardware accelerator at the datacenter.

According to some embodiments, the hardware accelerators may be included in a wrapper in the application package. The method may further include selecting one of the hardware accelerators based on a hardware map included in the application package. The application package may include multiple sub-packages, each sub-package including one of the hardware accelerators and a VM patching associated with the respective hardware accelerator. The datacenter characteristic may include a VM type, an operating system type, a processor type, and/or an accelerator type. Deploying the selected hardware accelerator at the datacenter may include reconfiguring the VM based on the selected hardware accelerator.

According to other embodiments, the method may further include deploying the selected hardware accelerator on a field-programmable gate array (FPGA) at the datacenter. Selecting one of the hardware accelerators may include selecting one of multiple hardware description language (HDL) files included in the application package, and deploying the selected hardware accelerator on the FPGA may include programming the FPGA based on the selected HDL file and one or more implementation parameters included in the application package. The implementation parameters may include netlist formation parameters and/or place-and-route parameters.

According to other examples, a virtual machine manager (VMM) to implement applications and associated hardware accelerators at a datacenter may include a memory configured to store instructions, a processing module coupled to the memory, and a configuration controller. The processing module may be configured to receive an application package including an application and multiple hardware accelerators associated with the application and deploy the application on a virtual machine (VM) at the datacenter. The configuration controller may be configured to select one of the hardware accelerators based on a datacenter characteristic and deploy the selected hardware accelerator at the datacenter.

According to some embodiments, the hardware accelerators may be included in a wrapper in the application package. The wrapper may be an extensible markup language (XML) wrapper. The configuration controller may be further configured to select one of the hardware accelerators based on a hardware map included in the application package. The application package may include multiple sub-packages, each sub-package including one of the hardware accelerators and a VM patching associated with the respective hardware accelerator. The datacenter characteristic may include a VM type, an operating system type, a processor type, and/or an accelerator type. The configuration controller may be further configured to deploy the selected hardware accelerator at the datacenter by reconfiguring the VM based on the selected hardware accelerator.

According to other embodiments, the configuration controller may be further configured to deploy the selected hardware accelerator on a field-programmable gate array (FPGA) at the datacenter. The configuration controller may be further configured to select one of the hardware accelerators by selecting one of multiple hardware description language (HDL) files included in the application package and deploy the selected hardware accelerator on the FPGA by programming the FPGA based on the selected HDL file and one or more implementation parameters included in the application package. The implementation parameters may include netlist formation parameters and/or place-and-route parameters.

According to further examples, a cloud-based datacenter may be configured to implement applications and associated hardware accelerators. The datacenter may include at least one virtual machine (VM) operable to be executed on one or more physical machines, a hardware acceleration module, and a datacenter controller. The datacenter controller may be configured to receive an application package including an application and multiple hardware accelerators associated with the application, deploy the application on the at least one VM, select one of the hardware accelerators based on a characteristic of the hardware acceleration module, and deploy the selected hardware accelerator on the hardware acceleration module.

According to some embodiments, the hardware accelerators may be included in an extensible markup language (XML) wrapper in the application package. The datacenter controller may be further configured to select one of the hardware accelerators based on a hardware map included in the application package. The application package may include multiple sub-packages, each sub-package including one of the hardware accelerators and a VM patching associated with the respective hardware accelerator. The characteristic of the hardware acceleration module may include a type of the at least one VM, an operating system type, a processor type, and/or an accelerator type. The datacenter controller may be further configured to deploy the selected hardware accelerator at the datacenter by reconfiguring the at least one VM based on the selected hardware accelerator.

According to other embodiments, the hardware acceleration module may be a field-programmable gate array (FPGA). The datacenter controller may be further configured to select one of the hardware accelerators by selecting one of multiple hardware description language (HDL) files included in the application package and deploy the selected hardware accelerator on the hardware acceleration module by programming the FPGA based on the selected HDL file and implementation parameters included in the application package. The implementation parameters may include netlist formation parameters and/or place-and-route parameters.

According to yet further examples, a method for packaging a datacenter application may include adding an application to a virtualization wrapper, generating multiple hardware accelerators associated with the application, each hardware accelerator generated based on a different datacenter hardware configuration, and adding the generated hardware accelerators to the virtualization wrapper.

According to some embodiments, the method may further include adding the multiple hardware accelerators in an extensible markup language (XML) wrapper in the virtualization wrapper and/or as multiple sub-packages, each sub-package including one of the hardware accelerators and virtual machine (VM) patching associated with the respective hardware accelerator. The datacenter hardware configuration may include a VM type, an operating system type, a processor type, and/or an accelerator type. The hardware accelerators may each be configured to be implemented on a field-programmable gate array (FPGA). The method may further include generating the hardware accelerators from multiple high-level hardware description language (HDL) files, each HDL file corresponding to a distinct accelerator class, using a netlist formation process, a place-and-route process, and/or a simulation process to create settings associated with each of the hardware accelerators, and adding the settings to the virtualization wrapper.

According to some examples, an application package for implementation at a datacenter may include a virtualization wrapper, an application included in the virtualization wrapper, and multiple hardware accelerators included in the virtualization wrapper, each hardware accelerator associated with the application and based on a different datacenter hardware configuration.

According to some embodiments, the virtualization wrapper may include an extensible markup language (XML) wrapper including the multiple hardware accelerators. The virtualization wrapper may also (or instead) include multiple sub-packages, each sub-package including one of the hardware accelerators and virtual machine (VM) patching associated with the respective hardware accelerator. The datacenter hardware configuration may include a VM type, an operating system type, a processor type, and/or an accelerator type. The hardware accelerators may each be configured to be implemented on a field-programmable gate array (FPGA). The hardware accelerators may be generated from multiple high-level hardware description language (HDL) files, each file corresponding to a distinct accelerator class, and the virtualization wrapper may include settings associated with each of the hardware accelerators and create from a netlist formation process, a place-and-route process, and/or a simulation process.

According to other examples, a method for implementing applications and associated hardware accelerators at a datacenter may include forming an application package by adding an application to a virtualization wrapper, generating multiple hardware accelerators associated with the application, each hardware accelerator generated based on a different datacenter hardware configuration, and adding the generated hardware accelerators to the virtualization wrapper. The method may further include receiving the application package at a datacenter, deploying the application on a virtual machine (VM) at the datacenter, selecting one of the hardware accelerators based on a datacenter characteristic or a hardware map included in the application package, and deploying the selected hardware accelerator at the datacenter.

According to some embodiments, the method may further include adding the multiple hardware accelerators in an extensible markup language (XML) wrapper in the virtualization wrapper and/or as multiple sub-packages, each sub-package including one of the hardware accelerators and virtual machine (VM) patching associated with the respective hardware accelerator. The datacenter hardware configuration may include a VM type, an operating system type, a processor type, and/or an accelerator type. The method may further include deploying the selected hardware accelerator on a field-programmable gate array (FPGA) at the datacenter. The method may further include generating the hardware accelerators from multiple high-level hardware description language (HDL) files, each HDL file corresponding to a distinct accelerator class, using a netlist formation process, a place-and-route process, and/or a simulation process to create settings associated with each of the hardware accelerators, and adding the settings to the virtualization wrapper.

According to other embodiments, selecting one of the hardware accelerators may include selecting one of multiple hardware description language (HDL) files included in the application package, and deploying the selected hardware accelerator on the FPGA may include programming the FPGA based on the selected HDL file and one or more implementation parameters included in the application package. The implementation parameters may include netlist formation parameters and/or place-and-route parameters.

According to further examples, a computer readable storage medium may store instructions which when executed on one or more computing devices execute a method for implementing an application and an associated hardware accelerator at a datacenter. The instructions may include receiving an application package including an application and multiple hardware accelerators associated with the application at a datacenter, deploying the application on a virtual machine (VM) at the datacenter, selecting one of the hardware accelerators based on a datacenter characteristic, and deploying the selected hardware accelerator at the datacenter.

According to some embodiments, the hardware accelerators may be included in a wrapper in the application package. The instructions may further include selecting one of the hardware accelerators based on a hardware map included in the application package. The application package may include multiple sub-packages, each sub-package including one of the hardware accelerators and a VM patching associated with the respective hardware accelerator. The datacenter characteristic may include a VM type, an operating system type, a processor type, and/or an accelerator type. Deploying the selected hardware accelerator at the datacenter may include reconfiguring the VM based on the selected hardware accelerator.

According to other embodiments, the instructions may further include deploying the selected hardware accelerator on a field-programmable gate array (FPGA) at the datacenter. Selecting one of the hardware accelerators may include selecting one of multiple hardware description language (HDL) files included in the application package, and deploying the selected hardware accelerator on the FPGA may include programming the FPGA based on the selected HDL file and one or more implementation parameters included in the application package. The implementation parameters may include netlist formation parameters and/or place-and-route parameters.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to implement applications and associated hardware accelerators at a datacenter, the method comprising:
receiving, at a datacenter, an application package including an application and a plurality of hardware accelerators associated with the application;
deploying the application on a virtual machine (VM) at the datacenter; selecting one of the plurality of hardware accelerators based on a datacenter characteristic; and
deploying the selected hardware accelerator at the datacenter on a field-programmable gate array (FPGA).

2. The method of claim 1, wherein the plurality of hardware accelerators are included in a wrapper in the application package.

3. The method of claim 1, further comprising selecting one of the hardware accelerators based on a hardware map included in the application package.

4. The method of claim 1, wherein the application package includes a plurality of sub-packages, each sub-package including one of the hardware accelerators and a VM patching associated with the respective one of hardware accelerators.

5. The method of claim 1, wherein the datacenter characteristic includes a VM type, an operating system type, a processor type, and/or an accelerator type.

6. The method of claim 1, wherein deploying the selected hardware accelerator at the datacenter includes reconfiguring the VM based on the selected hardware accelerator.

7. (canceled)

8. The method of claim 1, wherein:
selecting one of the hardware accelerators includes selecting one of a plurality of hardware description language (HDL) files included in the application package; and
deploying the selected hardware accelerator on the FPGA includes programming the FPGA based on the selected HDL file and one or more implementation parameters included in the application package, wherein the implementation parameters include netlist formation parameters and/or place-and-route parameters.

9. (canceled)

10. A virtual machine manager (VMM) to implement applications and associated hardware accelerators at a datacenter, the VMM comprising:
a memory configured to store instructions;
a processing module coupled to the memory, the processing module configured to:
receive an application package including an application and a plurality of hardware accelerators associated with the application; and
deploy the application on a virtual machine (VM) at the datacenter; and
a configuration controller configured to:
select one of the plurality of hardware accelerators based on a datacenter characteristic, wherein the datacenter characteristic includes a VM type, an operating system type, a processor type, and/or an accelerator type; and
deploy the selected hardware accelerator at the datacenter.

11. The VMM of claim 10, wherein the plurality of hardware accelerators are included in a wrapper in the application package.

12. The VMM of claim 11, wherein the wrapper is an extensible markup language (XML) wrapper.

13. The VMM of claim 10, wherein the configuration controller is further configured to select one of the hardware accelerators based on a hardware map included in the application package.

14. The VMM of claim 10, wherein the application package includes a plurality of sub-packages, each sub-package including one of the hardware accelerators and a VM patching associated with the respective one of the hardware accelerators.

15. (canceled)

16. The VMM of claim 10, wherein the configuration controller is configured to deploy the selected hardware accelerator at the datacenter by reconfiguring the VM based on the selected hardware accelerator.

17. The VMM of claim 10, wherein the configuration controller is configured to deploy the selected hardware accelerator on a field-programmable gate array (FPGA) at the datacenter.

18. The VMM of claim 17, wherein the configuration controller is further configured to:
select one of the hardware accelerators by selecting one of a plurality of hardware description language (HDL) files included in the application package; and
deploy the selected hardware accelerator on the FPGA by programming the FPGA based on the selected HDL file and one or more implementation parameters included in the application package, wherein the implementation parameters include netlist formation parameters and/or place-and-route parameters.

19. (canceled)

20. A cloud-based datacenter configured to implement applications and associated hardware accelerators, the datacenter comprising:
at least one virtual machine (VM) operable to be executed on one or more physical machines;
a hardware acceleration module; and
a datacenter controller configured to:
receive an application package including an application and a plurality of hardware accelerators associated with the application;
deploy the application on the at least one VM;
select one of the hardware accelerators based on a characteristic of the hardware acceleration module; and
deploy the selected hardware accelerator on the hardware acceleration module, wherein the hardware accelerators are included in an extensible markup language (XML) wrapper in the application package.

21. (canceled)

22. The datacenter of claim 20, wherein the datacenter controller is further configured to select one of the hardware accelerators based on a hardware map included in the application package.

23. The datacenter of claim 20, wherein the application package includes a plurality of sub-packages, each sub-package including one of the hardware accelerators and a VM patching associated with the respective one of the hardware accelerators.

24. The datacenter of claim 20, wherein the characteristic of the hardware acceleration module includes a type of the at least one VM, an operating system type, a processor type, and/or an accelerator type.

25. The datacenter of claim 20, wherein the datacenter controller is configured to deploy the selected hardware accelerator at the datacenter by reconfiguring the at least one VM based on the selected hardware accelerator.

26. The datacenter of claim 20, wherein the hardware acceleration module is a field-programmable gate array (FPGA).

27. The datacenter of claim 26, wherein the datacenter controller is configured to:
select one of the hardware accelerators by selecting one of a plurality of hardware description language (HDL) files included in the application package; and
deploy the selected hardware accelerator on the hardware acceleration module by programming the FPGA based on the selected HDL file and implementation parameters included in the application package.

28. The datacenter of claim 27, wherein the implementation parameters include netlist formation parameters and/or place-and-route parameters.

29.-49. (canceled)
